(19) United States
(12) Patent Application Publication
(10) Pub. No.: US 2007/0278819 A1
(43) Pub. Date: Dec. 6, 2007

(54) LIGHT WEIGHT MODULAR HINGED DOOR

(76) Inventors: Dinesh C. Seksaria, Novi, MI (US); John W. Cobes, Lower Burrell, PA (US); Edward A. Timko, Jeannette, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/742,196

(22) Filed: Apr. 30, 2007

Related U.S. Application Data
(60) Provisional application No. 60/796,077, filed on Apr. 28, 2006.

(51) Int. Cl. B60J 5/00

(52) U.S. Cl. 296/146.6; 296/146.11

(57) ABSTRACT

The present invention in one embodiment provides a door structure that includes a door shell having an exterior panel and an interior panel; an anti-intrusion beam positioned between the interior panel and the exterior panel of the door shell; a hinge end casting positioned at a first end of the door shell connected to a first end of the anti-intrusion beam through the interior panel; a lock end casting positioned at a second end of the door shell connected to a second end of the anti-intrusion beam through the interior panel; and a door hardware module mounted to the exterior face of the interior panel.

### CROSS REFERENCE TO RELATED APPLICATION

The present invention claims the benefit of U.S. provisional patent application 60/796,077, filed Apr. 28, 2006, the whole contents and disclosure of which is incorporated by reference as is fully set forth herein.

### FIELD OF THE INVENTION

The present invention in one embodiment relates to automotive door designs and more particularly to door designs in which the door hardware is incorporated as a modular assembly.

### BACKGROUND OF THE INVENTION

Hinged doors are commonly used in vehicles. Automotive door designs have evolved into a shell type design, in which the door's hardware is inserted into the interior of the shell through a number of holes in the door's inner panel. Automotive door designs in the United States need to meet U.S. Federal Motor Safety Standards (FMVSS) for side intrusion, and foreign government equivalents, as well as the OEM's targeted performance for parameters including door sag, noise and vibration etc. These requirements typically effect the weight and cost of the door design.

Automotive doors constructed of steel are typically formed from a very thin gage sheet, due to steel's very high density. In order to obtain the required structural performance, doors formed of thin gauge steel require a plurality of reinforcement structures formed from steel of a heavier gage. The weight of the door assembly and its cost is thus determined by the number and size of their additional reinforcements. To obtain the required structural performance, many discreet reinforcements have to be manufactured and assembled to the door's shell. These discreet reinforcements can present obstructions to inserting the variety of hardware components that are typically mounted to the interior of the door shell during manufacture and assembly.

The door hardware contained within the door shell of todays vehicles are becoming increasingly complex, in which some examples of door hardware include locks, latches, window lift mechanisms, and/or audio speakers. To accommodate the space requirements for fitting the door hardware within the reinforced door shell, the depth of door's cross section is typically on the order of 140 mm. Deep drawing to the required depths can be costly, wherein deep drawing of door shells is prone to difficulties in dimensional variations.

### SUMMARY OF THE INVENTION

In one embodiment of the present invention, a door is provided in which the door hardware is incorporated into the door by a modular assembly. In one embodiment, the inventive door structure includes:

a door shell having an exterior panel and an interior panel;

an anti-intrusion beam positioned between the interior panel and the exterior panel of the door shell;

a hinge end casting positioned at a first end of the door shell connected to a first end of the anti-intrusion beam through the interior panel;

a lock end casting positioned at a second end of the door shell connected to a second end of the anti-intrusion beam through the interior panel; and

a door hardware module mounted to the exterior face of the interior panel.

The term “door shell” means a structure composed on an interior panel and an exterior panel that are joined along at least a portion of the perimeter of the inner panel and the exterior panel to form a cavity between the interior and exterior panels. The term panel denotes construction of a sheet material. A sheet material may be a metal, polymer, or composite material having a thickness of less than 0.249″ (6.324 mm) and greater than 0.006″ (0.152 mm). The term anti-intrusion beam denotes a structure positioned within the door assembly to obstruct a side impact from breaching into the passenger compartment of the vehicle. The term “casting” denotes a structure that is formed by solidification of a molten material in a mold. The hinge end casting is a structure including provisions for attachment of a hinge that provides engagement to the body of a vehicle. The lock end casting is a structure including provisions for attachment of a locking member that provides for reversible locking engagement of the door assembly to the vehicle when in the closed position. The term door hardware module denotes an assembly of functional components onto a carrier that are connected as a single unit to the door shell. In one embodiment, the functional components include at least one of a window frame, window glass mechanism, door lock, door check, window motor, and wiring.

In another embodiment of the present invention, a door structure is provided including:

a door shell having an exterior panel and an interior panel;

an anti-intrusion beam positioned between the interior panel and the exterior panel of the door shell;

a hinge end structural member positioned at a first end of the door shell connected to a first end of the anti-intrusion beam through the interior panel;

a lock end structural member positioned at a second end of the door shell connected to a second end of the anti-intrusion beam through the interior panel; and

a door hardware module mounted to the exterior face of the interior panel.

The term hinge end structural member denotes an object having sufficient strength to carry the operative loads of the hinged engagement of the door assembly to the body of the vehicle without substantial plastic deformation of the object. The term lock end structural member denotes an object having sufficient strength to carry the operative loads of the reversible locking engagement of door to vehicle the body without substantial plastic deformation of the object. Plastic deformation means a deformation that is permanent after the release of an applied load. The hinge end structural member and/or the lock end structural member may be a cast metal or a molded polymer or composite.

In another aspect of the present invention a method is provided for forming a door structure including a door hardware module. Broadly, the method includes the steps of:

providing a door shell having an exterior panel and an interior panel;

positioning an anti-intrusion beam on the interior face of the interior panel of the metal door shell;

connecting a hinge end casting to a first end of the anti-intrusion beam through the interior panel of the door shell; and

connecting a door hardware module mounted to the exterior face of the interior panel.

### BRIEF DESCRIPTION OF THE DRAWINGS

The following detailed description, given by way of example and not intended to limit the invention solely thereto, will best be appreciated in conjunction with the accompanying drawings, wherein like reference numerals denote like elements and parts, in which:

FIG. 1a is a perspective view of one embodiment of the exterior surface of a door, in accordance with the present invention.

FIG. 1b is a perspective view of one embodiment of the interior surface of a door, in accordance with the present invention.

FIG. 2a is a perspective view of the exterior surface of one embodiment a door shell, in accordance with the present invention.

FIG. 2b is a perspective view of the interior face of one embodiment the interior panel of a door shell, in accordance with the present invention.

FIG. 2c is a cross-sectional view of one embodiment of a cup shaped structure of an interior door panel, in accordance with the present invention.

FIG. 2d is a cross-sectional view of one embodiment of the engagement of a cup shaped structure of an interior door panel to the exterior door panel, in accordance with the present invention.

FIG. 2e is a perspective view of the exterior face of one embodiment the interior panel of a door shell, in accordance with the present invention.

FIG. 3a is a perspective view of the interior side of one embodiment of the door hardware module, in accordance with the present invention.

FIG. 3b is a perspective view of the exterior side of one embodiment of the door hardware module, in accordance with the present invention.

FIG. 4 is a photographic representation of one embodiment of a modular door, in accordance with the present invention.

### DETAILED DESCRIPTION OF PREFERRED EMBODIMENTS

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

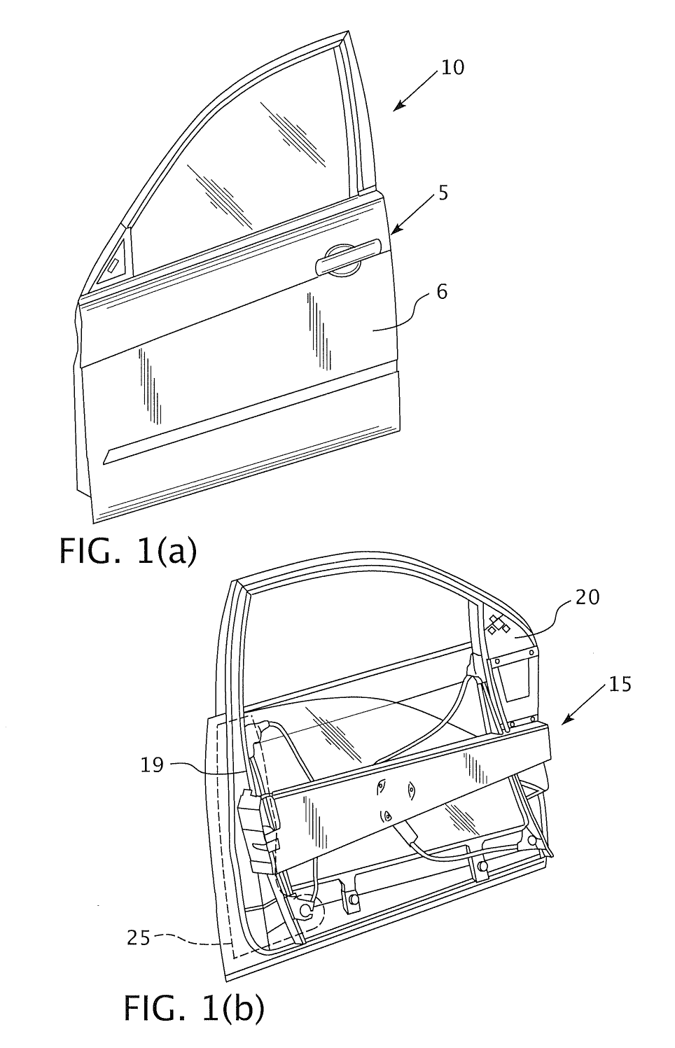

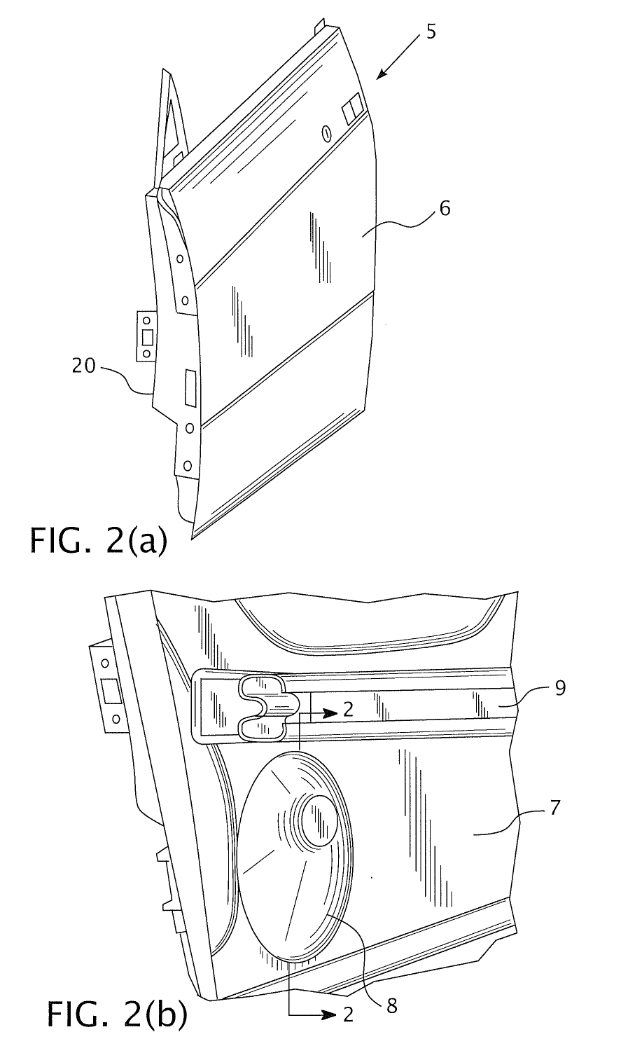

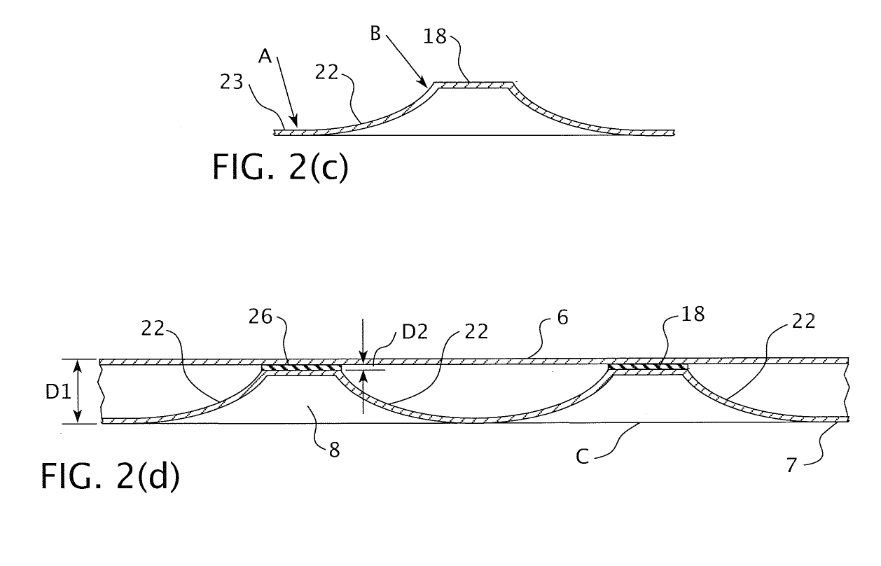

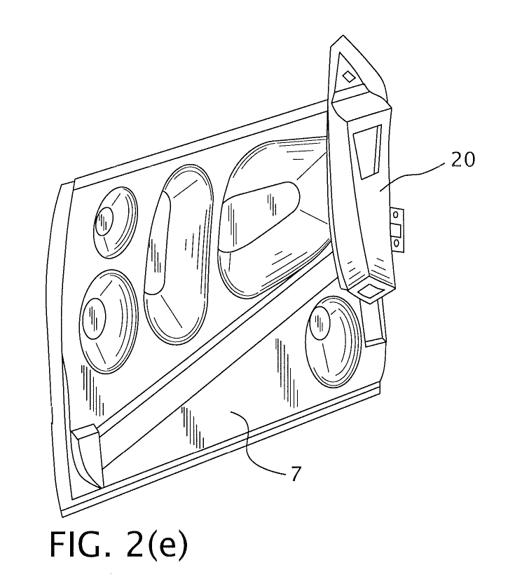

FIGS. 1a and 1b depict perspective views of a modular door 10 in accordance with the present invention. The term modular door means that the door is assembled of subassemblies. In one embodiment, the subassemblies of the modular door include the door shell 5 and the hardware module. The modular door 10 includes a door shell 5, a hinge end structural member 20, a lock end structural member 25, and a modular door hardware assembly 15. In one embodiment, the door shell 5 of the modular door 10 includes at least an exterior panel 6 and an interior panel 7, as depicted in FIGS. 2a-2e.

Referring to FIG. 2a, the exterior panel 6 is the outermost panel of the door shell 5 relative to the passenger compartment of the vehicle to which the modular door 10 is mounted. In one embodiment, the exterior face of the exterior panel 6 may have a geometry consistent with the vehicle body's configuration. In one embodiment, the exterior panel 6 can be formed with a constant or varying curved surface. In one embodiment, the interior face of the exterior panel 6 includes surfaces for connection with portions of the interior face of the interior panel 7 in a manner that enhances the mechanical properties of the door shell 5.

In one embodiment, the exterior panel 6 of the door shell 5 may be stamped from a metal sheet, such as an aluminum alloy. A stamped metal means a structure provided by a metalworking process by which sheet metal are punched using a press tool which is loaded on a machine press or stamping press to form the sheet into a desired shape. As used herein the term aluminum alloy means an aluminum metal with soluble alloying elements either in the aluminum lattice or in a phase with aluminum. Alloying element may include but are not limited to Cu, Fe, Mg, Ni, Si, Zn, Mn, Ti, Cr, V, Ag, Sn, Sc, and Li. In one embodiment, the exterior panel 6 may be formed Aluminum Association 6xxx series alloy. In yet another embodiment, the exterior panel 6 may be formed of Aluminum Association 6022 alloy. For example, Aluminum Association 6022 may include about 0.8 wt % to about 1.5 wt % Si, about 0.05 wt % to about 0.20 wt % Fe, about 0.01 wt % to about 0.11 wt % Cu, about 0.02 wt % to about 0.10 wt % Mn, about 0.45 wt % to about 0.7 wt % Mg, less than about 0.10 wt % Cr, less than 0.25 wt % Zn, less than 0.15 wt % Ti, and a balance of Al with impurities not totaling greater than 0.05 wt % each and 0.15 wt % total. In one embodiment, the door shell may be composed of a metal sheet construction, in which the thickness of the metal sheet may range from bout 0.8 mm to about 1.2 mm. In a further embodiment, the exterior panel 6 may be formed of a high strength polymer or composite.

Referring to FIG. 2b, the interior panel 7 of the door shell 5 may be the innermost panel of the door shell 5 relative to the passenger compartment of the vehicle to which the modular door 10 is mounted. The interior panel 7 may be also be referred to as a rigidifying sheet. In one embodiment, the interior panel 7 includes at least one cup shaped structure 8, wherein each of the cup shaped structure 8 are configured to be engaged to the exterior panel 6 in a manner that enhances the mechanical properties of the door shell 5, such as strength and rigidity. The term cup shaped structure 8 as used throughout the present application denotes a structure formed in the interior panel 7 having substantially planar face, hereafter referred to as connecting surface 18, for engaging the interior face of the opposing exterior panel 6 and an S-shaped sidewall 22 extending from the adjacent portions of the interior panel 7 in which the cup shaped structure 8 is formed to the connecting surface 18. In one embodiment, the interior panel 7 of the door shell 5 may be stamped from a metal sheet, such as aluminum alloy. In one embodiment, the interior panel 7 is composed of an Aluminum Association 6xxx series alloy, such as Aluminum Association 6022.

In one embodiment of the present invention, the cup-shaped structures 8 may be formed by a punch and die tool. In a further embodiment, the cup-shaped structure 8 may be formed by employing a punch and a die having a substantially cylindrical shape to develop the S-shape sidewall 22. The S-shaped sidewall 22 of the cup shaped structure 8 is curved in two opposing directions, the upper portion having a first curvature merging into the connecting surface 18 of the cup shaped structure 8, and lower portion having a second curvature merging into the adjacent portions of the interior panel 7 in which it the cup shaped structure 8 is formed.

FIG. 2c depicts a cross-sectional view along section line 2-2 of FIG. 2b of a cup shaped structure 8, in accordance with the present invention. In one embodiment, the S-shaped configuration of the cup shaped structure 8 may be defined as beginning at point before the transition A between the cup shaped structure's sidewall 22 and the adjacent portion of the interior panel 23 and may extend beyond the transition B between the projection's sidewall 22 and the interior panel's connecting surface 18.

In one embodiment, the connecting surface 18 and base of the cup shaped structure 8 is oblong or circular, but further embodiments having other geometries for the base of the stiffening structure have been contemplated and are within the scope of the present invention. In another embodiment, the geometry of the connection surface 18 and base geometry of the cup shaped structure 8 may include, but are not limited too tear drop shapes, as well as multi-sided configurations, including but not limited too: triangular and quadrilateral geometries.

In one embodiment of the cup shaped structure 8, the juncture between the sidewall 22 and the flat upper connecting portion 18 of the structural enhancing projection 8 is a smooth transition resulting in minimizing, if not eliminating inordinate stress concentrations at the juncture where the upper portion of the sidewall 22 merges into the connecting portion 18 of the cup shaped structures 8. It is further noted that in one embodiment the lower portion of the sidewall 22 similarly merges into the adjacent portion of the sheet 23 substantially minimizing stress concentrations. In an even further embodiment, the configuration of the cup shaped structures 8 in accordance with the present invention also provides for sidewalls 22 having a more equal stress distribution.

It is noted that the above example is provided for illustrative purposes only and that the present invention should not be limited to the geometries described above, as other geometries for the cup shaped structures 8 have also been contemplated and are within the scope of the present invention, so long as the structure does not weaken the door shell's rigidity. The exact dimensions of the cup shaped structures 8 and their disposition are optimized for the specific strength and stiffness required of the panel. The geometry, placement and spacing of the cup shaped structures 8 may be selected to provide clearance for the components of the modular door hardware assembly 15.

Referring to FIG. 2b, in one embodiment, an anti-intrusion beam 9 may be positioned on the interior face of the interior panel 7 of the door shell 5. The anti-intrusion 9 is positioned to provide protection to the occupants of the passenger compartment of the vehicle during side collisions and may be positioned in a lower portion of the door shell 5. In one embodiment, the anti-intrusion beam comprises a metal such, as an aluminum alloy. In another embodiment, metals other than aluminum have been contemplated, such as steel, as well as polymers and composites as the material of the anti-intrusion beam 9.

In one embodiment, the anti-intrusion beam 9 may be of an extruded construction. The term extruded means that the anti-intrusion beam is manufactured by providing a metal billet and pressing the metal billet through an extrusion die. In one embodiment, the extrusion die is a steel disk with an opening, wherein the size and shape of the opening corresponds to the intended cross-section of the extruded anti-intrusion beam 9. An extruded anti-intrusion beam 9 has a substantially constant cross section along at least a portion of the longitudinal length of the anti-intrusion beam. The longitudinal length of an extruded anti-intrusion beam is defined by the direction in the extruded anti-intrusion beam 9 is formed through the extrusion die. In one embodiment, the anti-intrusion beam 9 may be extruded of an Aluminum Association (AA) 6xxx alloy, including but not limited to AA 6013, 6022, 6082 or 6061, or an Aluminum Association (AA) 7xxx series alloy, including but not limited to AA 7013. In one embodiment, the anti-intrusion beam is of a sheet metal construction that may be composed of Aluminum Association (AA) 6xxx series alloy, including but not limited to AA 6013 and 6082.

In one embodiment, Aluminum Association (AA) 6013 is composed of about 0.6 wt % to about 1.0 wt % Si, les than about 0.50 wt. % Fe, about 0.6 wt. % to about 1.1 wt. % Cu, about 0.20 wt. % to about 0.8 wt. % Mn, about 0.8 wt. % to about 1.2 wt. % Mg, less than about 0.1 wt. % Cr, less than 0.25 wt. % Zn, less than 0.10 wt. % Ti, and a balance of Al with impurities not totaling greater than 0.05 wt. % each and 0.15 wt. % total. In one embodiment, Aluminum Association (AA) 6082 is composed of about 0.7 wt. % to about 1.3 wt. % Si, less than about 0.50 wt % Fe, less than 0.1 wt % Cu, from about 0.40 wt % to about 1.0 wt % Mn, from about 0.6 wt % to about 1.2 wt. % Mg, less than about 0.25 wt % Cr, less than about 0.20 Zn, less than about 0.10 wt % Ti and a balance of Al with impurities not totaling greater than 0.05 wt. % each and 0.15 wt. % total. In one embodiment, Aluminum Association (AA) 6061 is composed of about 0.40 wt % to about 0.8 wt % Si, less than about 0.7 wt % Fe, about 0.15 wt % to about 0.40 wt %, less than about 0.15 wt % Mn, about 0.8 wt % to about 1.2 wt % Mg, from about 0.04 wt % to about 0.35 wt % Cr, less than about 0.25 wt % Zn, less than about 0.15 wt % Ti, and a balance of Al with impurities not totaling greater than 0.05 wt. % each and 0.15 wt. % total.

In one embodiment, the anti-intrusion beam 9 may have a wall thickness ranging from 2.0 mm to about 5.0 mm. In another embodiment, the anti-intrusion beam 9 has a wall thickness ranging from approximately 2.0 mm to approximately 3.0 mm. _In one embodiment, the anti-intrusion beam 9 may be have a channel cross section, such as a C-channel cross section; box cross section; or an I-beam cross section. In an even further embodiment, the anti-intrusion beam 9 may have a round or rectangular tube configuration. In one embodiment, the anti-intrusion beam 9 is connected to the hinge end structural member 20 and the lock end structural member 25. In one embodiment, the anti-intrusion beam 9 is spot welded to the interior panel 7, and may further be connected to the hinge mount structural member 20 and the lock end structural member 25. It has been further contemplated that the anti-intrusion beam 9 may be adhesively connected to the interior panel 7. In one embodiment, the anti-intrusion beam 9 is further engaged to the interior face of the exterior panel 6 by a heat activated polymer foam adhesive. The engagement of the anti-intrusion beam 9 to the hinge end structural member 20 and the lock end structural member 25 will be discussed in greater detail below.

Still referring to FIG. 2b, in one embodiment a lock end structural member 25 may be positioned on the interior or exterior face of the interior panel 6. In one embodiment, the lock end structural member 25 is positioned on the interior face so as to be positioned between the interior panel 6 and the exterior panel 7. The lock end structural member 25 is a three dimensional structure, which may have a varying thickness in at least one dimension. In one embodiment, the lock end structural member 25 further includes rib structures configured to strengthen the member corresponding to the loads presented during door operation.

In one embodiment, the lock end structural member 25 is composed of a metal, such as aluminum, steel or magnesium, but may also be formed of polymers and composites. In one embodiment, the lock mount structure 25 is a casting of an aluminum alloy. A casting denotes a structure that is formed by solidification of a molten material in a mold. In one embodiment, the lock end structural member 25 is formed of an Aluminum Association (AA) 3xx series alloy. In one embodiment the lock end structural member is formed of Aluminum Association 356 or 357. Aluminum Association 356 typically includes about 6.5 wt. % to about 7.5 wt. % Si, less than about 0.6 wt. % Fe, less than about 0.25 wt. % Cu, less than 0.35 wt. % Mn, about 0.20 wt. % to about 0.45 wt. % Mg, less than 0.35 wt. % Zn, less than 0.25 wt. % Ti and a balance of Al with impurities not totaling greater than 0.05 wt % each and 0.15 wt % total. Aluminum Association A357 may include about 6.5 wt. % to about 7.5 wt. % Si, less than about 0.2 wt. % Fe, less than about 0.2 wt. % Cu, less than 0.1 wt. % Mn, about 0.40 wt. % to about 0.7 wt. % Mg, less than 0.1 wt. % Zn, from about 0.04 to about 0.2 wt. % Ti and a balance of Al with impurities not totaling greater than 0.05 wt % each and 0.15 wt % total. In one embodiment, the lock end structure member 25 includes a hollow portion that may be provided by employing a core during the casting process.

In one embodiment, the lock end structural member 25 includes provisions for providing engagement to the lock components of the modular door hardware assembly 15 and/or the locking components included within the door jam of the vehicle body. In one embodiment, the lock end structural member 25 provides attachment points for the modular hardware assembly 15 including the window frame. In one embodiment, the lock end structural member 25 may be mechanically fastened to the interior panel 7 using rivets or nut and bolt arrangements or similar type fasteners. In yet another embodiment, the lock end structural member 25 may also be welded or adhesively mounted.

Following the formation of the interior panel 7, the attachment of the anti-intrusion beam 9 and the attachment of the lock end structural member 25 when positioned on the interior face of the interior panel 7, the interior and exterior panels 7, 6 are joined together to provide the door shell 5. Referring to FIG. 2d depicting a cross-sectional view of a portion of one embodiment of a door shell 5 in accordance with the present invention, the dimension D1 separating the interior and exterior panels 7, 6 at it's greatest distance may be no greater than approximately 40 mm. In another embodiment, the dimension D1 separating the interior and exterior panels 7, 6 may range from approximately 30 mm to approximately 40 mm. In yet another embodiment, the dimension D1 separating the interior and exterior panels 7, 6 may be approximately 35 mm. In a further embodiment, the dimension D2 separating the connecting surface 18 of interior panel's 7 structural enhancing projections 8 from the corresponding portions of the interior face of the exterior panel 6 may be less than about 5 mm. In an even further embodiment, the dimension D2 separating the connecting surface 18 of interior panel's 7 structural enhancing projections 8 from the corresponding portions of the interior face of the exterior panel 6 may be less than about 3 mm. In yet an even further embodiment, the dimension D2 separating the connecting surface 18 of interior panel's 7 structural enhancing projections 8 from the corresponding portions of the interior face of the exterior panel 6 may range from about 1 mm to about 3 mm.

In one embodiment, the bonding between the connecting surface 18 of the structure enhancing projections 8 of the interior panel 7 and the interior face of the exterior panel 6 may be provided by an adhesive material. In one embodiment, the adhesive material may be a heat activated adhesive, such as a heat activated polymer foam adhesive including but not limited to heat activated expandable polymer foam adhesive. In one embodiment, the expandable adhesive is an anti-flutter adhesive of a poly-vinyl chloride plastisol base. In another embodiment, the expandable foam adhesive is a rubber based or elastomer based system. In one embodiment, the dimensions of the anti-intrusion beam 9 and the spacing between the interior panel 7 and the exterior panel 6 are selected so that the anti-intrusion beam 9 may also be adhesively bound to the interior face of the exterior panel 6.

In one embodiment, the connection between the interior and exterior door panels 7, 6 along the perimeter of the door shell 5 are provided by a hemmed portion along the side and bottom portions of the door shell 5. In one embodiment, the hemmed portion is provided by a flange extending from the edge of the exterior panel 6 that is bent over into engagement with the corresponding edges of the interior panel 7. In one embodiment, the bond at the hemmed portion may be adhesively strengthened. In one embodiment, the bond at the hemmed portion may be strengthened with a heat activated adhesive.

Referring to FIG. 2e, in one embodiment the hinge end structural member 20 is composed a metal, such as aluminum, steel or magnesium, but may also be formed of polymers and composites. In one embodiment, the hinge end structural member 20 is a casting of an aluminum alloy. In one embodiment, the hinge end structural member 20 is cast of an Aluminum Association (AA) 3xx series alloy, including but not limited to AA 356 and 357. In one embodiment, the hinge mount structural member 20 further includes rib structures configured to strengthen the member corresponding to the loads presented during door operation. In another embodiment, the hinge end structural member 20 includes a hollow portion that may be provided by employing a core during the casting process.

In one embodiment, the hinge end structural member 20 includes provisions for providing engagement with the hinge components of the door jam of the vehicle body. In one embodiment, the hinge end structural member 20 also includes a door check for ensuring that the door is not pivoted beyond it's designed range of motion. In one embodiment, the door check structure may be incorporated in the hinge end structure 20, and may be designed to correspond with a door check structure that is incorporated into the modular door hardware assembly 15, wherein the combined door check structures provide increased strength. In one embodiment, the hinge end structural member 20 provides attachment points for the modular hardware assembly 15, the window frame, and the exterior mirrors. In one embodiment, the hinge end structural member 20 may be mechanically fastened to the exterior face of the interior panel 7 using rivets, such as integral rivets, or nut and bolt arrangements, or similar type fasteners known in the art. In yet another embodiment, the hinge end structural member 20 may be welded or adhesively mounted to the interior panel 7. In an even further embodiment, the hinge end structural member 20 may be mounted using a combination of adhesive joining, welding, and mechanical fastening.

In one embodiment, the hinge end structural member 20 is connected to the first end of the anti-intrusion beam 9 through the interior panel 7, wherein the hinge end structural member 20 is positioned on the exterior face of the interior panel 7 and is mechanically fastened to the first end of the anti-intrusion beam 9 that is positioned on the interior face of the interior panel 7. In one embodiment, the mechanical fasteners may be rivets and/or nut and bolt arrangements. Additionally, in one embodiment the second end of the anti-intrusion beam 9 is connected to the lock end structural member 25, in which the anti-intrusion beam 9 may be positioned between the exterior and interior panels 6,7 of the door shell 5, wherein the connection of the anti-intrusion beam 9 to the exterior and interior panels 6, 7 of the door shell 5 may be provided by mechanical, adhesive joining, welding or combinations thereof.

In one embodiment, the interconnectivity provided by the hinge end structural member 20, lock end structural member 25, anti-intrusion beam 9, interior panel 7 and exterior panel 6 provide a door shell 5 having the mechanical properties, such as rigidity and strength, suitable for automotive applications. In one embodiment, the mechanical properties of the door shell 5 are further enhanced by the attachment of the modular door hardware assembly 15.

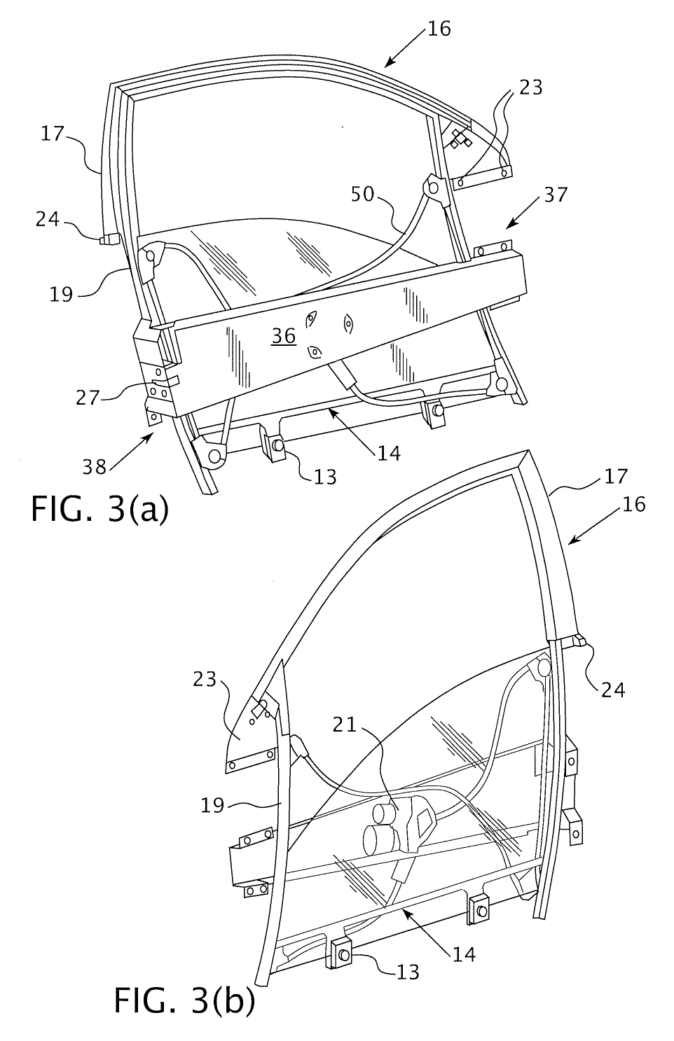

FIGS. 3a and 3b depict one embodiment of a modular door hardware assembly 15, in accordance with the present invention. In one embodiment, the modular door hardware assembly 15 may include a carrier 36, window glass guide track 19, window glass actuating mechanism 14, window motor 21, locking mechanism 27, door check mechanism (not shown), window cable 50 and door wiring. It is noted that any hardware typically employed in automotive door designs may be incorporated into the modular door hardware assembly 15 and is within the scope of the present invention. The carrier 36 provides mounting points for the door hardware, including but not being limited to the window components, in which the door hardware is assembled to the carrier 36 to provide the modular door hardware assembly 15, wherein following assembly the modular door hardware assembly 15 is connected to the door shell 5 as a single unit. In one embodiment, the carrier 36 may be referred to as a lock assembly carrier, wherein the lock assembly carrier houses the lock mechanism 27.

In one embodiment, the modular carrier 36 may be composed of stamped sheet metal, such as an aluminum alloy. In one embodiment, the modular carrier 36 may be composed of an Aluminum Association (AA) 6xxx series alloy, such as AA 6022. In another embodiment, the modular carrier may be composed of a steel sheet metal construction. In an yet another embodiment, the modular carrier 36 may formed of an extruded metal, such as an aluminum alloy. In one embodiment, the modular carrier 36 may be extruded from an Aluminum Association (AA) 6xxx series alloy, such as AA 6063. In a further embodiment, the modular carrier 36 may be composed of a polymeric or composite material.

In one embodiment, the carrier 36 may be connected to the exterior face of the interior panel 7 by mechanical engagement of the carrier's 36 first end 37 to the hinge end structural member 20, and by mechanical engagement of the window frame's 36 second end 38 to the lock end structural member 25. In one embodiment, the portion of the carrier 36 between the first and second end 37, 38 connections of the carrier 36 to the door shell 5 is spaced by a sufficient distance from the interior panel 7 to provide clearance for the window to be traversed between an open and closed position. In another embodiment, the first end 37 of the carrier 36 is connected directly to the hinge end structural member 20 and the second end 37 of the carrier 36 is connected to the lock end structural member 25 through the interior panel 7, in which the lock end structural member 25 is positioned between the exterior and interior panels 6, 7 of the door shell 5. More specifically, in one embodiment, when connecting the second end 37 of the modular carrier 36 to the lock end structural member 25 positioned within the door shell 5, the interior panel 7 is positioned between the lock end structural panel 25 and the second end 37 of the modular carrier 36. In one embodiment, the engagement of the carrier 36 to the interior panel 7 is provided by nut and bolt arrangements or rivets. In one embodiment, engagement of the carrier 36 to the door shell 5 by nut and bolt arrangements may facilitate maintenance of the modular door 10.

In one embodiment, the carrier 36 provides mounting points for the window glass actuating mechanism 14 and the window motor 21. In one embodiment, the window motor 21 is fastened to the carrier 36, and is operatively connected to the window glass actuating mechanism 14 by a window cable system 50, wherein actuation of the window motor 21 is transmitted to through the window cable system 50 to the window glass actuating mechanism 14. In one embodiment, the window glass actuating mechanism 14 may include attachments 13, such as clips, for engaging the bottom of the window glass and a guide structure for traversing the attachments when opening and closing the window. The carrier 36 may also include the locking mechanism 27, door check mechanism, as well as provide connection points for the window glass guide track 19.

In one embodiment, the window glass guide track 19 is formed of an extrusion that provides a c-channel including an open portion to guide the window pane. In another embodiment, the window glass guide track 19 is formed of an extrusion including a open portion in combination with a closed portion. More specifically, in one embodiment, in which the glass guide track 19 is formed of an open portion and a closed portion a box extrusion is formed including a flange to guide the window pane. In one embodiment, the window glass guide track 19 is a single extrusion that provides two open portions for channels corresponding to the sides of the window glass, wherein the upper portion of the extrusion provides the connection point for a co-molded upper window frame portion 17 that may provide a variable cross section when required to conform to the styling of the vehicle. In yet another embodiment, the window glass guide track 19 may be of a sheet metal construction.

In one embodiment, the window glass guide track 19 is connected to the door shell 5 through portions of the carrier 36 that are in close proximity to the hinge end structural member 20 and the lock end structural member 25 of the door assembly. In one embodiment, the window glass guide track 19 may be connected by at least one end (track) to a portion of the interior panel 7 below the window when in the closed position. In one embodiment, the window glass guide track 19 may be connected to the anti-intrusion beam 9, wherein in one embodiment the connection to the anti-intrusion beam 9 may be provided by mechanical fasteners, including but not limited to rivets and nut and bolt arrangements.

In one embodiment, the window glass track 19 may be extruded from an Aluminum Association (AA) 6xxx series alloy, such as AA 6063. In one embodiment, an upper portion 17 of the window frame may be provided by a polymer or composite material that is co-molded onto an extruded window glass guide track 19. The co-molded upper portion 17 may provide complex three dimensional shapes, varying cross sections, and may be formed with sharp comers and small radii to conform to the styling requirements of the vehicle. The co-molded upper frame portion 17 may be configured to have connection points 23, 24 to the hinge end structural member 20 and the lock end structural member 25. For the purposes of this disclosure term “co-molded” upper frame portion denotes that the upper portion of the extruded window glass track 19 may be inserted into a mold, wherein a polymeric or composite material is then molded onto the portion of the extruded glass track that is positioned within the mold. In one embodiment, the window glass track 19 may be connected to the door shell 5 by connecting points 23, 24 formed of a sheet material and configured to provide engagement to the cast hinge end structural member 30 and the cast lock end structural member 25.

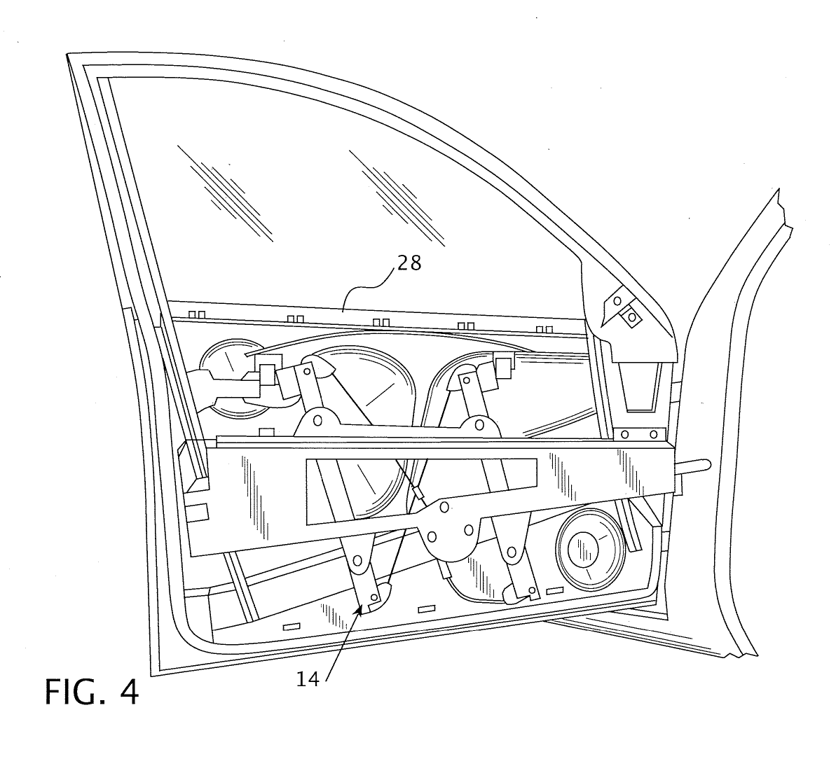

FIG. 4 is a photographic representation of the interior surface of the modular door assembly 5. In one embodiment a window felt 28 may be included at the upper edge of the interior door panel 7. Additionally, although not depicted, a trim panel may also be employed covering the modular door hardware assembly 15 and the conforming to the styling of the vehicle's interior. In one embodiment, the trim panel may be fastened to the interior panel 7 and/or the modular door hardware assembly 15.

While the present invention has been particularly shown and described with respect to the preferred embodiments thereof, it will be understood by those skilled in the art that the foregoing and other changes in forms of details may be made without departing form the spirit and scope of the present invention. It is therefore intended that the present invention not be limited to the exact forms and details described and illustrated, but fall within the scope of the appended claims.

What is claimed is:

1. A door structure comprising:
a door shell having an exterior panel and an interior panel;
an anti-intrusion beam positioned between the interior panel and the exterior panel of the door shell;
a hinge end casting positioned at a first end of the door shell connected to a first end of the anti-intrusion beam through the interior panel;
a lock end casting positioned at a second end of the door shell connected to a second end of the anti-intrusion beam through the interior panel; and
a door hardware module mounted to the exterior face of the interior panel.

2. The door structure of claim 1, wherein the door hardware module comprises at least one of a window frame, window glass mechanism, lock, door check, motor, and wiring.

3. The door structure of claim 2, wherein the window frame is connected to at least one of the lock end casting and the hinge end casting.

4. The door structure of claim 1, wherein the hinge end casting comprises a mounting point for a mirror.

5. The door structure of claim 1, wherein the hinge end casting comprises a mounting point for at least one hinge.

6. The door structure of claim 2, wherein the lock end casting comprises the mounting point for a door check.

7. The door structure of claim 1, wherein the hinge end casting is positioned on the exterior face of the interior panel and is mechanically fastened to the first end of the anti-intrusion beam positioned on the interior face of the interior panel.

8. The door structure of claim 1, wherein the lock end casting is positioned on the interior face of the interior panel.

9. The door structure of claim 1, wherein at least a portion of the inside panel is separated from the outside panel from approximately 30 mm to approximately 40 mm.

10. The door structure of claim 2, wherein the window frame comprises an extruded aluminum channel.

11. The door structure of claim 10, wherein the window frame is co-molded with a polymer.

12. The door structure of claim 1, wherein the door shell comprises aluminum.

13. The door structure of claim 1, wherein at least one of the hinge end casting and the lock end casting comprise aluminum.

14. The door structure of claim 1, wherein the interior panel comprises at least one cup shaped structure engaged to the exterior panel.

15. The door structure of claim 12, wherein the aluminum of the door shell is Aluminum Association 6022 alloy.

16. A method of forming a door structure comprising:
providing a metal door shell having an exterior panel and an interior panel;
positioning an anti-intrusion beam on the interior face of the interior panel of the metal door shell;
connecting a hinge end casting to a first end of the anti-intrusion beam through the interior panel of the metal door shell; and
connecting a door hardware module mounted to the exterior face of the interior panel.

17. The method of claim 16 comprising stamping the metal door shell from aluminum sheet.

18. The method of claim 16 comprising riveting the hinge end casting to the first end of the anti-intrusion beam through the interior panel of the metal door shell.

19. The method of claim 16 further comprising mounting the door hardware module comprises at least one of a window frame, window glass mechanism, lock, door check, motor, and wiring.

20. The method of claim 19 comprising forming the window frame from extruded aluminum tube.

21. The method of claim 20 comprising co-molding the window frame with a polymer.

22. A door structure comprising:
a door shell having an exterior panel and an interior panel;
an anti-intrusion beam positioned between the interior panel and the exterior panel of the door shell;
hinge end structural member positioned at a first end of the door shell connected to a first end of the anti-intrusion beam through the interior panel;
a lock end structural member positioned at a second end of the door shell connected to a second end of the anti-intrusion beam through the interior panel; and
a door hardware module mounted to the exterior face of the interior panel.

23. The door structure of claim 22, wherein the hinge end structural member comprises a polymer, metal or composite.

24. The door structure of claim 22, wherein the lock end structural member comprises a polymer, metal or composite.

25. The door structure of claim 22, wherein the interior panel and exterior panel comprise a polymer, metal or composite.

26. The door structure of claim 22, wherein the interior panel further comprises a cup shaped structure engaged to the exterior panel.
